(19) United States
(12) Patent Application Publication
(10) Pub. No.: US 2008/0082690 A1
(43) Pub. Date: Apr. 3, 2008

(54) System and method for the dynamic loading of protocol adapters

(75) Inventors: John E. Landry, Austin, TX (US); Christopher J. Conner, Jonestown, TX (US); Pradeep Kamath, Sunnyvale, CA (US); Pallavi Paranjape, Austin, TX (US); Tsen-Loong Peng, Austin, TX (US)

Correspondence Address: Roger Fulghum;Baker Botts L.L.P., One Shell Plaza, 910 Louisiana Street, Houston, TX, 77002-4995, US

(73) Assignee: DELL PRODUCTS L.P.

(21) Appl. No.: 11/541,258

(22) Filed: Sep. 29, 2006

(51) Int. Cl. G06F 15/16

(52) U.S. Cl. 709/246

(57) ABSTRACT

A system and method is disclosed for the dynamic load of protocol adapters in a client-server environment. In operation, the client and a coupled data server may have different communications protocols. At startup or run-time, the client accesses a protocol factory and retrieves a protocol adapter that is operable to convert communications between the protocol of the data server and the protocol of the client. The identification of the protocol adapter from the protocol factory is made by testing each protocol adapter on a serial basis to identify the first protocol adapter that is able to convert communications between the protocol of the data server and the protocol of the client.

### TECHNICAL FIELD

The present disclosure relates generally to computer systems and information handling systems, and, more particularly, to a system and method for the dynamic loading of protocol adapters.

### BACKGROUND

As the value and use of information continues to increase, individuals and businesses seek additional ways to process and store information. One option available to these users is an information handling system. An information handling system generally processes, compiles, stores, and/or communicates information or data for business, personal, or other purposes thereby allowing users to take advantage of the value of the information. Because technology and information handling needs and requirements vary between different users or applications, information handling systems may vary with respect to the type of information handled; the methods for handling the information; the methods for processing, storing or communicating the information; the amount of information processed, stored, or communicated; and the speed and efficiency with which the information is processed, stored, or communicated. The variations in information handling systems allow for information handling systems to be general or configured for a specific user or specific use such as financial transaction processing, airline reservations, enterprise data storage, or global communications. In addition, information handling systems may include or comprise a variety of hardware and software components that may be configured to process, store, and communicate information and may include one or more computer systems, data storage systems, and networking systems.

Information handling systems may be included as elements of a distributed computing environment. With respect to distributed computing environments, Web-Based Enterprise Management is a set of standard technologies developed to unify the management of distributed computing environments. One goal of the WBEM initiative is to establish a set of standard-based management tools to facilitate the exchange of data across disparate technologies and platforms. The exchange of data across disparate technologies and platforms is limited, however, by the various implementations of the WBEM standard. These various implementations of WBEM include a Windows-based version known as Windows Management Instrumentation (WMI) and an open source version known as OpenWBEM. In addition, WMI and OpenWBEM are implemented with different communications protocols. WMI is implemented with the Distributed Component Object Model (DCOM) communications protocol, and OpenWBEM is implemented with the CIM-XML over HTTP communications protocol. Other versions of the WBEM standard may soon be offered and each implemented on different communications protocol. The existence of multiple protocols between the WBEM standards limits the interoperability between client and server to a single communications protocol. As an example, an open source client on Linux will be unable to communicate with a Windows-based server over DCOM.

### SUMMARY

In accordance with the present disclosure, a system and method is disclosed for the dynamic load of protocol adapters in a client-server environment. In operation, the client is coupled to a data server. The data server may operate according to one of several different communications protocols. At startup or run-time, the client accesses a protocol factory within the client to retrieve a protocol adapter from a protocol library within the client. The identification of the protocol adapter by the protocol factory can be accomplished by testing each protocol adapter on a serial basis to identify the first protocol adapter that is able to convert communications between the protocol of the data server and the protocol of the client.

The system and method disclosed herein is technically advantageous because it provides a method for converting communications between devices in a WBEM environment. The system and method disclosed herein allows devices to operate according to the WBEM standard despite operating according to different communications protocols. The system and method disclosed herein is also advantageous because the client can communicate with any number of N data servers in a heterogenous environment. Regardless of the communications protocol of a particular data server, the client can select an appropriate protocol adapter and communicate with the data server. In addition, the placement of the protocol adapters on each client removes the need of loading each of the protocol adapters on each of the servers of a network. Instead, the protocol adapters are loaded on each of the client computers of the network.

The system and method disclosed herein is additionally advantageous in that it provides for the dynamic loading and execution of adapters to enable communications with servers in a WBEM environment. The system and method disclosed herein allows any client to communicate with any server without the pre-installation of adapter software on the server and regardless of the communications protocol in place at the server. Other technical advantages will be apparent to those of ordinary skill in the art in view of the following specification, claims, and drawings.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 is a diagram of a network;

FIG. 2 is a flow diagram of a method for adding a protocol adapter to the protocol factory; and

FIG. 3 is a flow diagram of a method for selecting a protocol adapter to be implemented by the client in a client-server network.

### DETAILED DESCRIPTION

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communication with external devices as well as various input and output (I/O) devices, such as a keyboard, a mouse, and a video display. The information handling system may also include one or more buses operable to transmit communications between the various hardware components.

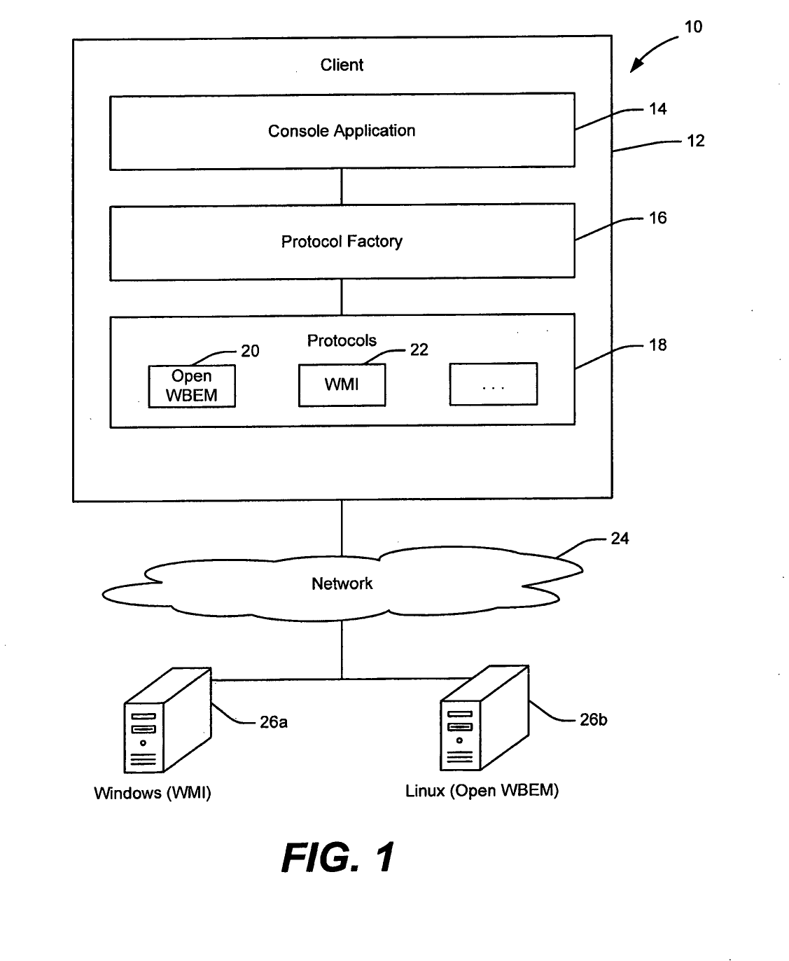

Shown in FIG. 1 is a diagram of a network, which is indicated generally at 10. Network 10 includes two data servers 26a and 26b. Data server 26a is configured according to the Windows Management Instrumentation (WMI) protocol and data server 26b is implemented according to the OpenWBEM protocol. Servers 26a and 26b are coupled to a network node or network cloud 24 to a client, which is indicated at 12. Each of the data servers 26 may provide any form of information to client 12, including files, web pages, or data in any other form. In operation, servers 26 and client 12 may operate according to different communications protocols. To resolve any incompatibility among the protocols, client 12 loads and runs a protocol adapter. A protocol adapter is a software application or utility that converts communications from a first protocol—used by the client—to the second protocol of the server.

Included within client 12 is a protocol factory 16. A client application 14 is coupled to protocol factory 16. Protocol factory 16 is internal to client 12 and acts as an interface to and a server of protocol adapters to client 12 from protocol library 18. Protocol library 18 includes a number of protocol adapters. Among the protocol adapters are a protocol adapter 20 for an open source Open WBEM protocol and a protocol adapter for Windows (WMI). In operation, protocol factory 16 loads one of the protocol adapters dynamically at startup or at run-time of an application seeking access to one of the servers 26. The selection of the protocol adapter to be loaded by the protocol factory is made on the basis of the Internet Protocol (IP) address of the server. The identification of the IP address of the server is made through an online discovery process in which client 12 accesses the network 24 to identify the IP address of the data server 26.

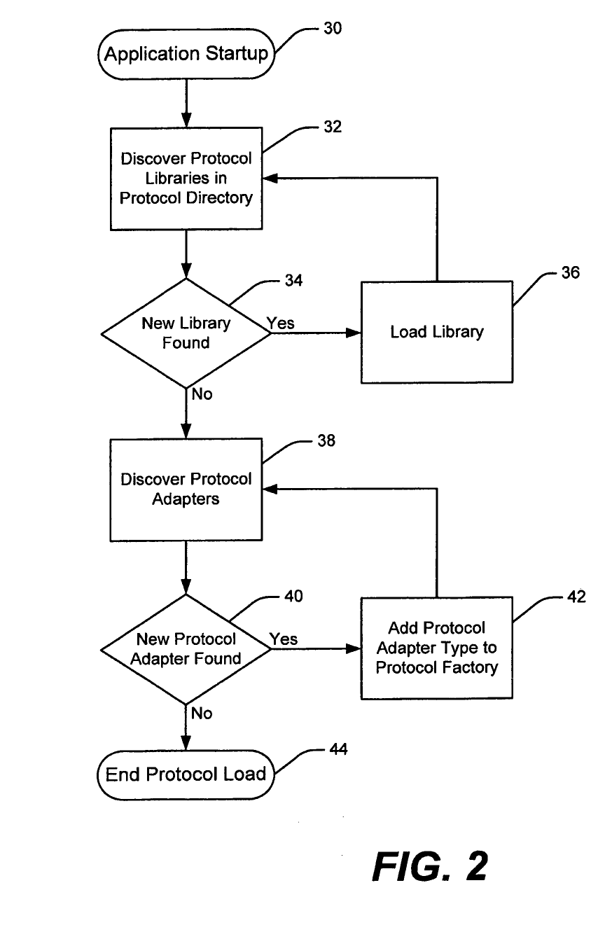

Protocol adapters can be added to the protocol library over time. Through the addition of protocol adapters to protocol library 18, protocol factory 16 can select one of the additional protocols to account for the addition of communications protocol and servers to network 10. Shown in FIG. 2 is a flow diagram of a method for adding a protocol adapter to the protocol library. Protocol factory 16 includes an interface program in which an administrator can add a protocol adapter to the protocol library. After the administrators saves the new protocol adapter to the protocol library, all protocol adapters included in the library are loaded and included in a discovery process during the next following initiation of an application 14 in client 12 seeking access to one of the servers 26. Protocol adapters are often added to protocol library 18 in groups of adapters known as protocol libraries.

With reference to FIG. 2, an application on client 12 is started at step 30. At step 32, the client accesses protocol factory 16 and attempts to discover whether any additional protocol libraries exist within the protocol library 18. As part of the discovery process, the application compares the existing libraries in protocol library 18 with the most recent list of libraries in protocol library 18. At step 34, it is determined if a new library has been saved to protocol factory 18. If a new library has been saved to protocol library 18, the library is loaded at step 36 and is identified by the protocol factory as being a newly added library within the library of protocol adapters in protocol library 18. After the completion of step 36, the flow diagram loops back to step 32 to continue the process of locating all of the previously unrecognized libraries in protocol library 18. If it is determined at step 34 that a new library has not been added to the protocol factory or once it is determined that all newly added protocol libraries have been loaded, the flow diagram continues at step 38, where the client determines if new protocol adapters exist in protocol library 18. If, for example, a new library has been added to protocol library 18, at least one new protocol adapter will be present in the protocol library. At step 40, it is determined if a new protocol adapter is present in protocol factory 20. If a new protocol adapter is present, the protocol adapter is loaded at step 42 and identified by the protocol factory as being an available protocol adapter. Following step 42, the flow diagram loops to step 38, where the process of identifying each newly added protocol adapter continues. If it is determined at step 40 that the protocol library includes no new protocol adapters or once it is determined that all newly added protocol adapters have been loaded, the protocol load process ends at step 44.

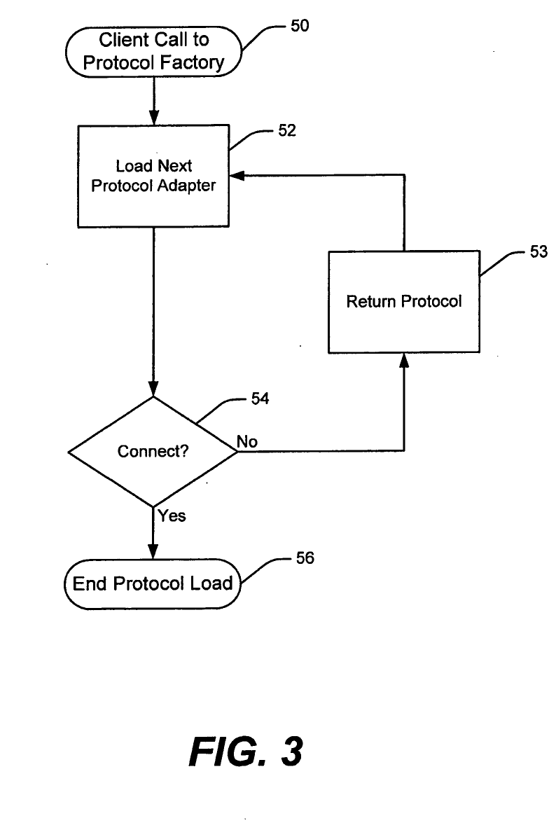

FIG. 3 is a flow diagram of a method for selecting a protocol adapter to be used by the client 12. At step 50, client 12 calls protocol factory 16. The call by the client to the protocol factory to retrieve a protocol adapter can be made at the initiation of the client, the initiation of an application at the client, or at a run-time on the basis of a predetermined event, such as an attempt by the client 12 to access one of the servers 26. At step 52, the protocol factory loads a first or next protocol adapter from protocol library 18. At step 54, the client executes a connection program to determine if the client can execute the protocol adapter to communicate with the selected server 26. If the connection is not successful, the protocol adapter is returned to the protocol library at step 53 and the flow diagram loops back to step 52, where the next protocol adapter from protocol library is loaded. Once it is determined at step 54 that client 12 can execute the retrieved protocol adapter and communicate successfully with server 26, the client uses the protocol adapter for the purpose of converting communications to and from the protocol of the client to the protocol of the server. At step 56, protocol adapter discovery ends. The process of identifying the correct protocol for the client occurs in a manner that is transparent to the client. As such, the client is not aware that a discovery process is being conducted, and the client is also not aware of the protocol adapter that is selected for communications with the data server.

The system and method disclosed herein is advantageous because the client can communicate with any number of N data servers in a heterogenous environment. Thus, regardless of the communications protocol of a particular data server, the client can select an appropriate protocol adapter and communicate with the data server. In addition, the placement of the protocol adapters on each client removes the need of loading each of the protocol adapters on each of the servers of a network. Instead, the protocol adapters are loaded on each of the client computers of the network.

The system and method disclosed herein is additionally advantageous in that it provides for the dynamic loading and execution of adapters to enable communications with servers in a WBEM environment. The system and method disclosed herein allows any client to communicate with any server without the pre-installation of adapter software on the server and regardless of the communications protocol in place at the server. As the WBEM standard becomes more prevalent and is applied to other devices, such as printers and other networked items, additional protocols can be added to the system described herein to permit clients of the system to communicate with these devices. It should also be recognized that the system and method disclosed herein is not limited in its application to clients and severs that implement the WBEM standard. Rather, the system and method disclosed herein may be employed to facilitate communication between any two endpoints that communicate according to different communication standards. Although the present disclosure has been described in detail, it should be understood that various changes, substitutions, and alterations can be made hereto without departing from the spirit and the scope of the invention as defined by the appended claims.

What is claimed is:

1. A method for providing communications between a client and a data server, wherein the client is associated with a first communications protocol and the server is associated with a second communications protocol, comprising:
accessing a protocol factory from the client;
locating a protocol adapter from the protocol factory for converting data between the first communications protocol and the second communications protocol;
executing at the client the protocol adapter at the client for converting data between the client and the server.

2. The method for providing communications between a client and a data server of claim 1, wherein the client and the server are configured according to the Web-Based Enterprise Management standard.

3. The method for providing communications between a client and a data server of claim 1, wherein the step of locating a protocol adapter from the protocol factory comprises the step of locating a protocol adapter within a protocol library accessible by the protocol factory.

4. The method for providing communications between a client and a data server of claim 1, wherein the step of locating a protocol adapter from the protocol factory comprises the step of testing each protocol adapter located at the protocol factory on a serial basis to locate a protocol adapter that is operable to convert data between the client and the server.

5. The method for providing communications between a client and a data server of claim 1, wherein the step of locating a protocol adapter from the protocol factory comprises the step of locating a protocol adapter on the basis of the IP address of the data server.

6. The method for providing communications between a client and a data server of claim 1, wherein the step of accessing the protocol factory from the client comprises the step of accessing the protocol factory from the client at startup of an application on the client.

7. The method for providing communications between a client and a data server of claim 1, wherein the step of accessing the protocol factory from the client comprises the step of accessing the protocol factory at run-time on the basis of a request by the client of data from the data server.

8. The method for providing communications between a client and a data server of claim 1, further comprising the step of selecting a protocol adapter at the client following a determination that the protocol adapter is able to convert data between the client and the server.

9. The method for providing communications between a client and a data server of claim 1, wherein the client and the server are configured according to the Web-Based Enterprise Management standard.

10. The method for providing communications between a client and a data server of claim 9, wherein the step of locating a protocol adapter from the protocol factory comprises the step of testing each protocol adapter located at the protocol factory on a serial basis to locate a protocol adapter that is operable to convert data between the client and the server

11. A client-server network, comprising:
a data server; wherein the data server operates according to a first communications protocol; and
a client coupled to the data server, comprising:
at least one application operable to execute on the client and access data from the data server; and
a protocol factory, wherein the protocol factory is operable to access a set of protocol adapters;
wherein the client operates according to a second communications protocol, and wherein the client is operable to retrieve a protocol adapter through the protocol factory for converting communications between the client and the server;

12. The client-server network of claim 11, wherein the client and the server are configured according to the Web-Based Enterprise Management standard.

13. The client-server network of claim 11, wherein the client is coupled to the data server through an Internet-based communications link.

14. The client-server network of claim 11, wherein the client is operable to retrieve a protocol adapter through the protocol factory by locating a protocol adapter within a protocol library at the client.

15. The client-server network of claim 11, wherein the client is operable to retrieve a protocol adapter through the protocol factory by locating a protocol adapter by serially testing each protocol adapter to locate a protocol adapter that is operable to convert data between the client and the server.

16. The client-server network of claim 11, wherein the client is operable to retrieve a protocol adapter through the protocol factory by locating a protocol adapter on the basis of the IP address of the data server.

17. The client-server network of claim 11,
wherein the client and the server are configured according to the Web-Based Enterprise Management standard;
wherein the client is coupled to the server through an Internet-based communications link;
wherein the client is operable to retrieve a protocol adapter through the protocol factory by locating a protocol adapter by serially testing each protocol adapter located at the protocol factory to locate a protocol adapter that is operable to convert data between the client and the server.

18. A method for converting data between a data server and a client, wherein the data server operates according to a first communications protocol and the client operates according to a second communications protocol, comprising:
from the client, accessing a protocol factory within the client;
identifying a protocol adapter through the protocol factory, wherein the identified protocol adapter is operable to convert communications between the first communications protocol and the second communications protocol;
loading to the protocol adapter within the client and executing the protocol adapter at the client to convert communications between the first communications protocol and the second communications protocol.

19. The method for converting data between a data server and a client of claim 18, wherein the client and the server are configured according to the Web-Based Enterprise Management standard.

20. The method for converting data between a data server and a client of claim 18, wherein the step of identifying a protocol adapter through the protocol factory comprises the step of testing each protocol adapter located through the protocol factory on a serial basis to locate a protocol adapter that is operable to convert data between the first communications protocol and the second communications protocol.
